(19) United States
(12) Patent Application Publication
(10) Pub. No.: US 2008/0205247 A1
(43) Pub. Date: Aug. 28, 2008

(54) Multi-Radiation Beam Optical Scanning Device

(75) Inventors: Bernardus Hendrikus Wilhelmus Hendriks, Eindhoven (NL); Sjoerd Stallinga, Eindhoven (NL); Stein Kuiper, Eindhoven (NL); Teunis Willem Tukker, Eindhoven (NL); Coen Theodorus Hubertus Fransiscus Liedenbaum, Eindhoven (NL); Albert Hendrik Jan Immink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,319

(22) PCT Filed: Apr. 26, 2006
(86) PCT No.: PCT/IB2006/051306

§ 371 Date: Nov. 1, 2007

(30) Foreign Application Priority Data
May 3, 2005 (EP) 05103684.6

(51) Int. Cl. G11B 7/135; G11B 7/125; G11B 7/12

(52) U.S. Cl. 369/112.17

(57) ABSTRACT

An optical scanning device for scanning an information layer (2) of an optical record carrier (3). The device includes a radiation source (7) for providing at least a first radiation beam of a first polarization along a first optical path, and a second radiation beam of a second, different polarization along a second, different optical path. An objective lens system, having an optical axis (19a), is arranged to converge the radiation beams on the information layer A beam-deflecting element (30) comprising a birefringent material is orientated such that each of said polarized radiation beams experiences a different index of refraction upon passing through the birefringent material, and is arranged to refract at least the first radiation beam towards the optical axis.

The present invention relates to an optical scanning device utilizing at least two radiation beams, and to methods of manufacture of such devices. Particular embodiments of the present invention are suitable for use in optical scanning devices compatible with two or more different formats of optical record carrier, such as compact discs (CDs), conventional digital versatile discs (DVDs), and so-called next generation DVDs, such as Blu-ray Disc (BD).

Optical record carriers exists in a variety of different formats, with each format generally being designed to be scanned by a radiation beam of a particular wavelength. For example, CDs are available, inter alia, as CD-A (CD-audio), CD-ROM (CD-read only memory) and CD-R (CD-recordable), and are designed to be scanned by means of a radiation beam having a wavelength (λ) of around 785 nm. DVDs, on the other hand, are designed to be scanned by means of a radiation beam having a wavelength of about 650 nm, and Blu-ray Discs are designed to be scanned by means of a radiation beam having a wavelength of about 405 nm. Generally, the shorter the wavelength, the greater the corresponding capacity of the optical disc e.g. a Blu-ray Disc-format disc has a greater storage capacity than a DVD-format disc.

It is desirable for an optical scanning device to be compatible with different formats of optical record carriers, e.g. for scanning optical record carriers of different formats responding to radiation beams having different wavelengths whilst preferably using one objective lens system. For instance, when a new optical record carrier with higher storage capacity is introduced, it is desirable for the corresponding new optical scanning device used to read and/or write information to the new optical record carrier to be backward compatible i.e. to be able to scan optical record carriers having existing formats.

Unfortunately, optical discs designed for being read out at a certain wavelength are not always readable at another wavelength. For example, in a CD-R-format disc, special dyes have to be applied in the recording stack in order to obtain a high modulation of the scanning beam at λ=785 nm. At λ=660 nm, the modulation signal from the disc becomes so small (due to the wavelength sensitivity of the dye) that readout at this wavelength is not feasible.

In order to allow compatibility between the different formats, optical scanning device must incorporate radiation sources arranged to provide radiation beams at each of the relevant wavelengths. A separate, discrete radiation source can be utilized for each wavelength. Alternatively, a multi-wavelength radiation source (e.g. dual wavelength lasers) can be utilized. Both approaches typically result in different radiation beams being output from different positions and/or at different angles i.e. the different radiation beams are not output along a single, common optical path.

For example, in multi-laser single chip radiation sources, the individual lasers are typically separated by a distance of around 100 micron, in the radial scanning direction (relative to the scanning direction of the optical disc). Consequently, the optical axes of the different lasers do not coincide, thus making it difficult to use a single detector system to detect all of the radiation beams reflected from the optical record carrier. Furthermore, one or more of the beams will enter the objective lens system obliquely, resulting in coma, and thus reducing the tolerance of the system to alignment errors.

One solution to this problem is to utilize a diffraction grating to attempt to align the optical paths of two radiation beams emitted from two different emission points. US 2002/01142527 describes an optical pickup device incorporating such a diffraction element. The diffraction element is a step-like diffraction element. The step size is selected such that a first radiation beam will travel through the diffraction element without being diffracted, whilst a second, different wavelength radiation beam will be diffracted by the diffraction element.

Diffraction elements can be relatively lossy. However, for optical scanning devices using three or more different wavelength radiation beams, designing a suitable diffraction grating having both a high efficiency of transmission of incident radiation and ample positioning tolerance (to allow for manufacturing tolerances) is problematic.

U.S. Pat. No. 5,278,813 describes the use of a wedge-shaped prism. The prism is rotatable, so as to provide a shift in the position of the light spot on the optical disc. The prism is rotated so as to ensure that the light spot from a second light beam is incident at the same position on the disc as a light spot from a first light beam. The disadvantage of such a system is that it utilizes mechanical movement of the prism. The utilization of beam deflecting devices that require mechanical movement is undesirable, as such devices are prone to mechanical fatigue and/or susceptible to vibration.

It is an aim of embodiments of the present invention to provide a multi-radiation beam optical scanning device that addresses one or more of the problems of the prior art, whether referred to herein or otherwise. It is an aim of particular embodiments of the present invention to provide an improved optical scanning device utilizing at least three different radiation beams.

According to a first aspect of the present invention there is provided an optical scanning device for scanning an information layer of an optical record carrier, the device comprising a radiation source for providing at least a first radiation beam of a first polarization along a first optical path, and a second radiation beam of a second, different polarization along a second, different optical path; an objective lens system, having an optical axis, for converging said radiation beams on said information layer; and at least one beam-deflecting element comprising a layer of birefringent material orientated such that each of said polarized radiation beams experiences a different index of refraction upon passing through the birefringent material, and arranged to refract at least said first radiation beam towards the optical axis.

A birefringent material is a material having at least two different indices of refraction. The beam-deflecting element thus utilizes the polarization of the incident radiation beam to vary the degree by which the radiation beam is deflected (i.e. along/towards the optical axis). Thus, a beam-deflecting element is provided that does not require mechanical movement.

The optical scanning device may comprise a detector for detecting at least a portion of each of said radiation beams reflected from the optical record carrier; and a beam splitter for transmitting the incident radiation beam received from the radiation source towards the optical record carrier, and for transmitting said reflected radiation beams received from the optical record carrier, towards the detector; wherein at least one of said beam-deflecting elements is positioned between the radiation source and the beam splitter.

The device may comprise a detector for detecting at least a portion of each of said radiation beams reflected from the optical record carrier; and a beam splitter for transmitting the incident radiation beam received from the radiation source towards the optical record carrier, and for transmitting said reflected radiation beams received from the optical record carrier, towards the detector; wherein at least one of said beam-deflecting elements is positioned between the beam splitter and the detector.

The optical scanning device may comprise a detector for detecting at least a portion of each of said radiation beams reflected from the optical record carrier; and a beam splitter for transmitting the incident radiation beam received from the radiation source towards the optical record carrier, and for transmitting said reflected radiation beams received from the optical record carrier, towards the detector; wherein at least one of said beam-deflecting elements is positioned between the beam splitter and the position of the optical record carrier.

The birefringent material may have two surfaces extending transverse the optical paths of the radiation beams, a first surface being arranged to refract the first radiation beam towards the optical axis, and a second surface being arranged to subsequently refract the first radiation beam substantially along the optical axis.

The beam-deflecting element may comprise a transparent material contacting the birefringent material and extending transverse the optical paths of the optical radiation beams, having a refractive index nₜ where n₁≧nₜ≧n₂, n₁ and n₂ being respectively the maximum and minimum refractive indices of the birefringent material; the preferential axis of the birefringent material being orientated such that at least one of said polarized radiation beams experiences a refractive index of substantially nₜ upon passing through the birefringent material.

The beam-deflecting element may comprise an additional layer of birefringent material having a preferential axis orientated such that each polarized radiation beam experiences a different index of refraction upon passing through the additional layer of birefringent material.

The beam-deflecting element may be arranged to transmit at least one of the radiation beams provided by the radiation source, without substantial refraction of the beam.

The radiation source may be arranged to provide a third radiation beam along a third, different optical path, each radiation beam having a different wavelength; and the optical scanning device further comprises at least one half-wave plate for altering the polarization of incident radiation beams, the half-wave plate being arranged to alter the polarization of at least one of said radiation beams and not to alter the polarization of at least another one of said radiation beams.

The optical scanning may comprise at least one further beam-deflecting element comprising a birefringent material orientated such that different polarized radiation beams experience a different index of refraction upon passing through the birefringent material, said half-wave plate being positioned between two of the beam-deflecting elements.

According to a second aspect of the present invention there is provided a method of manufacturing an optical scanning device for scanning an information layer of an optical record carrier, the method comprising providing a radiation source for providing at least a first radiation beam of a first polarization along a first optical path, and a second radiation beam of a second, different polarization along a second, different optical path;

providing an objective lens system, having an optical axis, for converging said radiation beams on said information layer; and providing at least one beam-deflecting element comprising a birefringent material orientated such that each of said polarized radiation beams experiences a different index of refraction upon passing through the birefringent material, and arranged to refract at least said first radiation beam towards the optical axis.

Preferred embodiments will now be described, by way of example only, with reference to the accompanying drawings, in which:

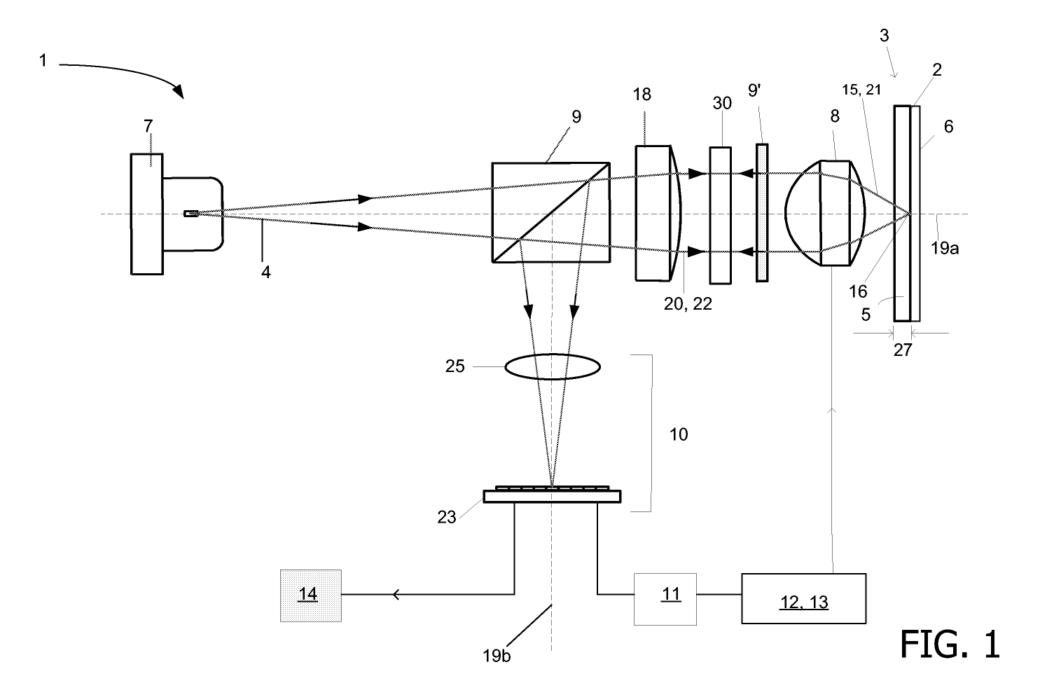

FIG. 1 is a schematic diagram of an optical scanning device according to an embodiment of the present invention;

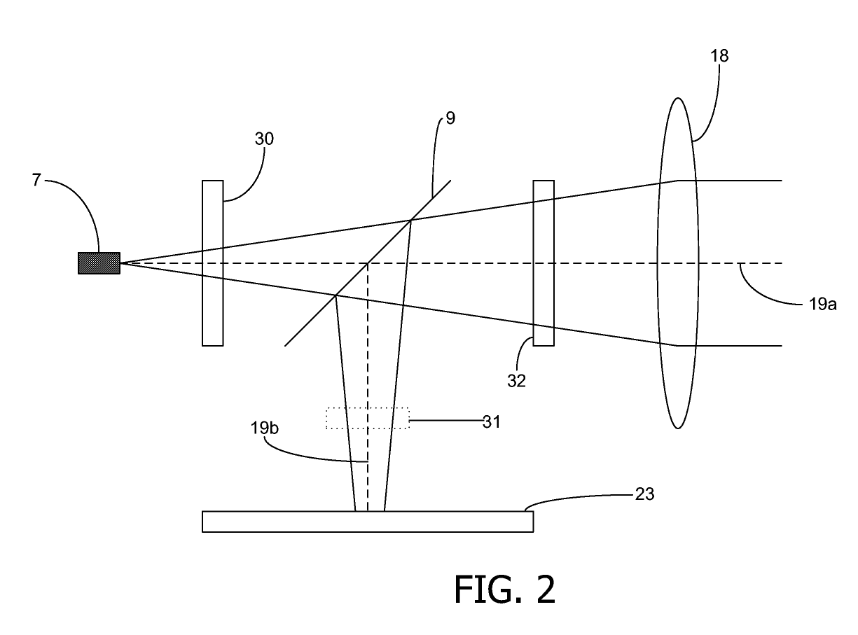

FIG. 2 is a schematic diagram of a portion of an optical scanning device according to an alternative embodiment of the present invention;

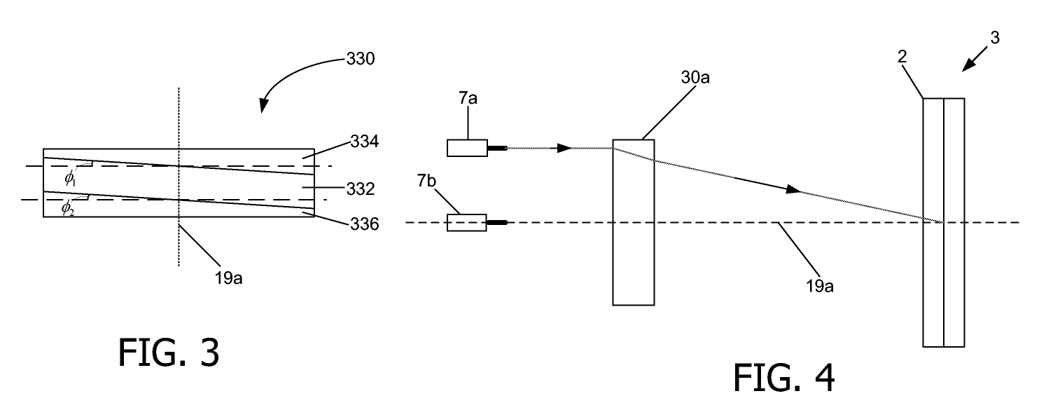

FIG. 3 is a simplified side view cross-section of a beam-deflecting element incorporating a birefringent material, suitable for use in the optical scanning devices of FIGS. 1 and 2;

FIGS. 4 to 6 are simplified schematic diagrams of optical scanning devices incorporating one or more beam-deflecting elements, in accordance with different embodiments of the present invention.

The present inventors have realized that a suitable beam-deflecting element, for deflecting different radiation beams towards the optical axis, can be implemented using a birefringent material. A birefringent material is a material which has at least two different refractive indexes for the different polarization components of a beam of light. The birefringent material is used within the beam-deflecting element to provide at least one surface for refraction of the radiation beam. Refraction is the phenomenon which occurs when a radiation beam crosses a boundary between two media in which the phase velocity of the radiation beam differs (i.e. the materials have different refractive indices). This leads to a change in direction of propagation of the radiation beam, in accordance with Snell's Law. The degree of refraction (i.e. the difference between the angle of incidence and the angle of refraction of a radiation beam) at a boundary between media of different refractive indexes is dependent upon the difference in refractive index between the two media.

Thus, by utilizing a birefringent material as one of the media defining the boundary (i.e. the surface of the birefringent material) the degree of refraction provided by the boundary will be dependent upon the polarization of the incident radiation beam.

An optical scanning device including such a beam-deflecting element will now be described in more detail, and then subsequently further details of the beam-deflecting element described.

FIG. 1 shows a device 1 for scanning a first information layer 2 of a first optical record carrier 3 by means of a first radiation beam 4, the device including an objective lens system 8.

The optical record carrier 3 comprises a transparent layer 5, on one side of which information layer 2 is arranged. The side of the information layer 2 facing away from the transparent layer 5 is protected from environmental influences by a protective layer 6. The side of the transparent layer facing the device is called the entrance face. The transparent layer 5 acts as a substrate for the optical record carrier 3 by providing mechanical support for the information layer 2. Alternatively, the transparent layer 5 may have the sole function of protecting the information layer, while the mechanical support is provided by a layer on the other side of the information layer 2, for instance by the protective layer 6 or by an additional information layer and transparent layer connected to the uppermost information layer. It is noted that the information layer has first information layer depth 27 that corresponds, in this embodiment as shown in FIG. 1, to the thickness of the transparent layer 5. The information layer 2 is a surface of the carrier 3.

Information is stored on the information layer 2 of the record carrier in the form of optically detectable marks arranged in substantially parallel, concentric or spiral tracks, not indicated in the figure. A track is a path that may be followed by the spot of a focused radiation beam. The marks may be in any optically readable form, e.g. in the form of pits, or areas with a reflection coefficient, or a direction of magnetization different from the surroundings, or a combination of these forms. In the case where the optical record carrier 3 has the shape of a disc.

As shown in FIG. 1, the optical scanning device 1 includes a radiation source 7, a collimator lens 18, a beam splitter 9, an objective lens system 8 having an optical axis 19a, a diffractive part 24, and a detection system 10. Furthermore, the optical scanning device 1 includes a servo circuit 11, a focus actuator 12, a radial actuator 13, and an information-processing unit 14 for error correction.

In this particular embodiment, the radiation source 7 is arranged for consecutively or separately supplying a first radiation beam 4, a second radiation beam 4′ and a third radiation beam 4″. For example, the radiation source 7 may comprise a tunable semiconductor laser for consecutively supplying two of the radiation beams 4, 4′ and 4″ with a separate laser supplying the third beam, or three semiconductor lasers for separately supplying these radiation beams. The output paths of at least two of the radiation beams 4, 4′ and 4″ are different. For instance, two or more of the radiation beams may be emitted from different physical positions of the radiation source 7 and/or at different angles relative to the optical axis 19a of the objective lens system. Typically, each of the radiation beams have an optical axis that is parallel with respect to each other, and emitted from different positions. For instance, the optical axes of the radiation beams may be parallel, and 100 microns apart, due to the emission points of the radiation beams from the radiation source 7 being 100 microns apart. This separation of the radiation beams is normally in the radial scanning direction (relative to the direction scanned by the beam on the optical record carrier).

The radiation beam 4 has a wavelength λ₁ and a polarization p₁, the radiation beam 4′ has a wavelength λ₂ and a polarization p₂, and the radiation beam 4″ has a wavelength λ₃ and a polarization p₃. The wavelengths λ₁, λ₂, and λ₃ are all different. Preferably, the difference between any two wavelengths is equal to, or higher than, 20 nm, and more preferably 50 nm. Two or more of the polarizations p₁, p₂, and p₃ may differ from each other.

The collimator lens 18 is arranged on the optical axis 19a for transforming the divergent radiation beam 4 into a substantially collimated beam 20. Similarly, it transforms the radiation beams 4′ and 4″ into two respective substantially collimated beams 20′ and 20″ (not shown in FIG. 1).

The beam splitter 9 is arranged for transmitting the radiation beams along an optical path towards the objective lens system 8. In the example shown, the radiation beams are transmitted towards the objective lens system 8 by transmission through the beam splitter 9. Preferably, the beam splitter 9 is formed with a plane parallel plate that is tilted at an angle α with respect to the optical axis, and more preferably α=45°. In this particular embodiment the optical axis 19a of the objective lens system 8 is common with an optical axis of the radiation source 7.

A beam-deflecting element 30 is located on the optical axis 19a. In this particular embodiment, the beam-deflecting element 30 is positioned between the collimator lens 18 and the objective lens system 8.

Each of the radiation beams is transmitted through the beam deflection element 30. Further, the beam-deflecting element 30 is arranged to direct each of the radiation beams towards the optical axis 19a of the objective lens system 8. In this particular embodiment, the optical axis 19a is common with an optical axis of the radiation source 7 i.e. at least one of the radiation beams has an optical path along the optical axis 19a. Any such radiation beams, that are already aligned with the optical axis 19a, are transmitted without refraction by the beam-deflecting element 30. Any of the radiation beams that are not aligned with the optical axis 19a are directed towards the optical axis 19a by the beam-deflecting element 30. Preferably, the beam-deflecting element 30 is arranged to refract each of the non-aligned beams, so as to align with the optical axes i.e. such that each beam path is along the optical axis 19a.

Aligning each of the radiation beams with the optical axis 19a will generally require two refractive interfaces. The first refractive interface will refract the radiation beam in the direction of the optical axis 19a i.e. such that it is at an angle heading towards the optical axis 19a. The second refractive interface will then refract the optical path of the radiation beam again, so as to be along the optical axis 19a.

The objective lens system 8 is arranged for transforming the collimated radiation beam 20 to a first focused radiation beam 15 so as to form a first scanning spot 16 in the position of the information layer 2.

During scanning, the record carrier 3 rotates on a spindle (not shown in FIG. 1), and the information layer 2 is then scanned through the transparent layer 5. The focused radiation beam 15 reflects on the information layer 2, thereby forming a reflected beam 21 which returns on the optical path of the forward converging beam 15. The objective lens system 8 transforms the reflected radiation beam 21 to a reflected collimated radiation beam 22.

The beam splitter 9 separates the forward radiation beam 20 from the reflected radiation beam 22 by transmitting at least part of the reflected radiation 22 along an optical path towards the detection system 10. In the illustrated example, the reflected radiation beam 22 is transmitted towards the detection system 10 by reflection from a plate within beam splitter 9. In the particular embodiment shown, the beam splitter 9 is a polarizing beam splitter. A quarter waveplate 9′ is positioned along the optical axis 19a between the beam splitter 9 and the objective lens system 8. The combination of the quarter waveplate 9′ and the polarizing beam splitter 9 ensures that the majority of the reflected radiation beam 22 is transmitted towards the detection system 10 along detection system optical axis 19b. The detection system optical axis 19b is a continuation of the optical axis 19a, due to the beam splitter 9 transmitting at least part of the reflected radiation 22 towards the detection system 10. Thus, the objective lens system optical axis comprises the axes indicated by reference numerals 19a and 19b.

The detection system 10 includes a convergent lens 25 and a detector 23, which are arranged for capturing said part of the reflected radiation beam 22.

The detector is arranged to convert said part of the reflected beam to one or more electrical signals.

One of the signals is an information signal, the value of which represents the information scanned on the information layer 2. The information signal is processed by the information processing unit 14 for error correction.

Other signals from the detection system 10 are a focus error signal and a radial tracking error signal. The focus error signal represents the axial difference in height along the Z-axis between the scanning spot 16 and the position of the information layer 2. Preferably, this signal is formed by the “astigmatic method” which is known from, inter alia, the book by G. Bouwhuis, J. Braat, A. Huijser et al, “Principles of Optical Disc Systems”, pp. 75-80 (Adam Hilger 1985, ISBN 0-85274-785-3). The radial tracking error signal represents the distance in the XY-plane of the information layer 2 between the scanning spot 16 and the center of track in the information layer 2 to be followed by the scanning spot 16. This signal can be formed from the “radial push-pull method” which is also known from the aforesaid book by G. Bouwhuis, pp. 70-73.

The servo circuit 11 is arranged for, in response to the focus and radial tracking error signals, providing servo control signals for controlling the focus actuator 12 and the radial actuator 13 respectively. The focus actuator 12 controls the position of the objective lens 8 along the Z-axis, thereby controlling the position of the scanning spot 16 such that it coincides substantially with the plane of the information layer 2. The radial actuator 13 controls the radial position of the scanning spot 16 so that it coincides substantially with the center line of the track to be followed in the information layer 2 by altering the position of the objective lens 8.

The objective lens 8 is arranged for transforming the collimated radiation beam 20 to the focused radiation beam 15, having a first numerical aperture NA₁, so as to form the scanning spot 16. In other words, the optical scanning device 1 is capable of scanning the first information layer 2 by means of the radiation beam 15 having the wavelength λ₁, the polarization pi and the numerical aperture NA₁.

Furthermore, the optical scanning device in this embodiment is also capable of scanning a second information layer 2′ of a second optical record carrier 3′ by means of the radiation beam 4′, and a third information layer 2″ of a third optical record carrier 3″ by means of the radiation beam 4″. Thus, the objective lens system 8 transforms the collimated radiation beam 20′ to a second focused radiation beam 15′, having a second numerical aperture NA₂ so as to form a second scanning spot 16′ in the position of the information layer 2′. The objective lens 8 also transforms the collimated radiation beam 20″ to a third focused radiation beam 15″, having a third numerical aperture NA₃ so as to form a third scanning spot 16″ in the position of the information layer 2″.

Any one or more of the scanning spots 16, 16′, 16″ may be formed with two additional spots for use in providing an error signal. These associated additional spots can be formed by providing an appropriate diffractive element in the path of the optical beam 20.

Similar to the optical record carrier 3, the optical record carrier 3′ includes a second transparent layer 5′ on one side of which the information layer 2′ is arranged with the second information layer depth 27′, and the optical record carrier 3″ includes a third transparent layer 5″ on one side of which the information layer 2″ is arranged with the third information layer depth 27″.

In this embodiment, the optical record carrier 3, 3′ and 3″ are, by way of example only, a “Blu-ray Disc”—format disc, a DVD—format disc and a CD-format disc, respectively. Thus, the wavelength λ₁ is comprised in the range between 365 and 445 nm, and preferably, is 405 nm. The numerical aperture NA₁ equals about 0.85 in both the reading mode and the writing mode. The wavelength λ₂ is comprised in the range between 620 and 700 nm, and preferably, is 650 nm. The numerical aperture NA₂ equals about 0.6 in the reading mode and is above 0.6, preferably 0.65, in the writing mode. The wavelength λ₃ is comprised in the range between 740 and 820 nm and, preferably is about 785 nm. The numerical aperture NA₃ is below 0.5, and is preferably 0.45 for the reading of information from CD-format discs, and preferably between 0.5 and 0.55 for writing information to CD-format discs.

FIG. 2 shows a simplified schematic diagram of a radiation path through a portion of a scanning device in accordance with an alternative embodiment of the present invention. The scanning device illustrated in FIG. 2 generally corresponds to that shown in FIG. 1, with identical reference numerals being utilized to illustrate similar features. In this particular embodiment, the beam-deflecting element 30 is placed in the radiation path between the radiation source 7 and the beam splitter 9, instead of being located between the collimator 18 and the optical record carrier 3 (as shown in FIG. 1). In the embodiment illustrated in FIG. 1, in which the beam-deflecting element 30 is located between the beam splitter 9 and the optical record carrier 3, the beam-deflecting element 30 is arranged to direct the radiation beams towards the optical axis 19a in the “forward direction” i.e. as the radiation beam is directed towards the optical scanning device. In the “backward” direction, as the radiation beam reflected from the optical record carrier passes through the beam-deflecting element 30, the radiation beams may be directed away from the optical axis by the configuration shown in FIG. 1. The arrangement indicated in FIG. 2 has the advantage that the spots incident upon the detector 23 are co-axial i.e. the spots are not displaced with respect to each other.

However, as the beam-deflecting element 30 is placed in the diverging beam between the radiation source 7 and the collimator 18, astigmatism may be introduced into the transmitted radiation beam. To prevent any such astigmatism affecting the resulting spot 16 incident on the information layer 2 of the optical record carrier 3, an astigmatism correction plate 32 may be added to the radiation beam path. The astigmatism correction plate 32 is placed in the radiation beam path between the beam splitter 9 and the collimator 18. The astigmatism correction plate is a transparent plate. The astigmatism correction plate 32 is arranged for correcting the transmitted radiation beam of undesirable astigmatism introduced into the beam e.g. by the beam-deflecting element 30. The plate 32 is arranged to apply the opposite astigmatism to the beam, so as to cancel out the undesirable astigmatism from the beam. For instance, the astigmatism correction plate may comprise one or more refractive interfaces, so as to provide the desired level of astigmatism to the transmitted beam for correction purposes.

By placing the astigmatism correction plate 32 between the beam splitter 9 and the collimator 18, then radiation reflected from the optical carrier 3 will only pass through this correction plate 32, and not the beam-deflecting element 30. Consequently, this reflected beam, as transmitted by the beam divider 9 towards the detector 23, will contain astigmatism. In the astigmatic method described above, typically the lens 25 shown in FIG. 1 will be used to introduce astigmatism into the transmitted beam, for ensuring the beam incident on the detector has the desired astigmatism for determining the focus error signal. In this particular embodiment, the desired amount of astigmatism is provided by the astigmatism correction plate, and hence the lens 25 can be eliminated from the optical scanning device.

A beam deflector element as described herein may also be placed in the position indicated by the dotted lines 31 in FIG. 2, between the beam splitter 9 and the detector 23. A beam deflector element located in such a position can be utilized to ensure that radiation beams of different wavelengths are incident on a single detector system e.g. to prevent radiation beams at different positions/of different wavelengths requiring detection by separate quadrant detectors.

The beam-deflecting element may be located in position 31 as an alternative to the beam-deflecting element 30 being located between the radiation source and the beam splitter 9, or being located between the beam splitter 9 and the optical record carrier 3, or in conjunction with a beam-deflecting element located in either of these positions. For instance, locating a first beam deflector element between the beam splitter 9 and the optical record carrier 3 could be utilized to ensure that different radiation beams are incident on the optical record carrier at substantially the same spot, with subsequently a beam deflector element located between beam splitter 9 and detector 23 ensuring that each of the reflected radiation beams can be detected by a single detector system e.g. a single quadrant detector.

FIG. 3 illustrates one example of a beam-deflecting element 330 incorporating a layer of birefringent material 332. The birefringent material 332 is, in this embodiment, sandwiched between two additional layers 334, 336. Both additional layers 334, 336 are transparent. Each of the layers 332, 334, 336 extends transverse the optical axis of the element (which, in the example shown in FIG. 3, is common with the optical axis 19a of the optical lens system). The term transverse is understood to mean across, and does not limit any of the layers to being planar.

In the particular example shown, layers 334 and 336 are formed of a common material. In this particular example, both layers have a refractive index nₜ, where n₁≧nₜ≧n₂, n₁ and n₂ being respectively the maximum and minimum refractive indices of the birefringent material.

At least one of the surfaces of the birefringent material is not orthogonal to the optical axis of the beam deflector element. In the example shown, the birefringent material 332 has a first surface (defined by the boundary with material 334) at an angle Ø₁ to the normal to the optical axis. The birefringent material 332 also has a second surface (defined by the boundary with the material 336) at an angle Ø₂ to the normal to the optical axis. In FIG. 3, the transverse dotted lines represent the normal to the optical axis, and the solid transverse lines the boundaries or interfaces between the materials.

It will be seen that both Ø₁ and Ø₂ are non-zero. Thus, any beam of radiation incident upon the relevant surface, parallel to the optical axis, will be refracted by the interface (assuming that there is a difference in refractive index between the two media defining the interface).

The refractive index experienced by a radiation beam passing through the birefringent material is dependent upon the polarization of the radiation beam. For example, a radiation beam passing through the material that is horizontally polarized may experience a refractive index n₁, whilst a vertically polarized radiation beam passing through the birefringent material may experience a refractive index n₂ (assuming the birefringent material is appropriately orientated). Thus, the polarization of each radiation beam will control the degree to which the radiation beam is refracted at any given surface/interface between two media.

The refractive index of birefringent material varies with direction. A measure of birefringence is the difference between the greatest and least value of refractive index.

Birefringence arises due to anisotropy in the material e.g. crystalline anisotropy, molecular orientation, frozen in or imposed strains. Due to the anisotropy, each material can be regarded as having a preferential axis. For instance, in a liquid crystal the preferential axis is termed the director, and corresponds to the average orientation of the elongated molecules.

References to the birefringent material being orientated include the concept of the preferential axis of the birefringent material being orientated in a particular direction.

Thus, by appropriate control of the polarization of the radiation beams and the angles of the different boundaries, a beam-deflecting element can be arranged to provide any desired change in the optical path of an incident radiation beam.

For instance, by appropriate control of the angles of the first and second surfaces of the birefringent material, the first surface can be configured to deflect the path of an off-axis incident radiation beam towards the optical axis. The second surface can similarly be configured to refract an incident radiation beam in the direction parallel to the optical axis.

By appropriate selection of the thickness of the birefringent material (i.e. length of the birefringent material layer along the optical axis), the second surface can be arranged to direct the radiation beam (already refracted by the first surface) along the optical axis i.e. if the radiation beam crosses the second surface at the point at which that surface crosses the optical axis.

The beam-deflecting element can also be arranged to not provide any beam deflection to an incident radiation beam i.e. to not refract an incident radiation beam. This can be achieved by ensuring that the refractive index experienced by the radiation beam on passing through the birefringent material is (substantially) equal to the refractive index (e.g. nₜ) of the adjacent media.

Various other configurations of a beam-deflecting element can also be arranged. For instance, the additional layers 334, 336 could have different refractive indices. One or more of these layers could also be birefringent. Alternatively, the central layer (shown as layer 332 in FIG. 3) could be of uniform refractive index, with the two outer layers being formed of birefringent materials. These birefringent materials could be the same material, or could be different birefringent materials having different ranges of indices of refraction.

The beam-deflecting element could be formed of simply a single layer of birefringent material. Alternatively, it can be formed of any two or more layers of material, any one or more of which can be birefringent.

In the above embodiments, the beam-deflecting element has been shown as having no optical power i.e. it is not arranged to converge (or diverge) the radiation beam, but simply to alter the path of the beam due to each of the surfaces being planar. In other embodiments, the beam-deflecting element may have an optical power e.g. by providing curved surfaces or by interfaces. Such an optical power may be suitable for facilitating the focusing of the radiation beam on to the surface of the optical record carrier.

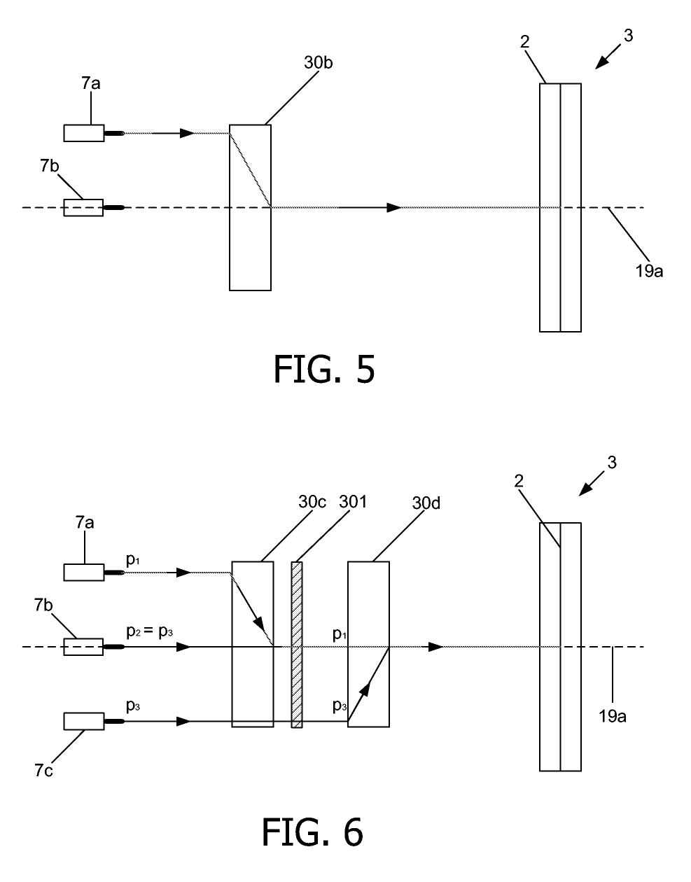

FIGS. 4 to 6 each show much more simplified modes of operation of an optical scanning device incorporating one or more beam deflector elements 30a-30d. In the optical scanning devices shown in FIGS. 4 and 5, two radiation sources 7a, 7b are provided. FIG. 6 shows an optical scanning device including three radiation sources 7a, 7b and 7c. Each radiation source 7a, 7b, 7c is arranged to provide a separate, different beam of radiation. Each of the beams of radiation is utilized to scan an information layer of a respective optical record carrier. For instance, both FIGS. 4 and 5 show the radiation beam from radiation source 7a being used to scan an information layer 2 of a first type of optical record carrier 3. For ease of explanation, none of the intervening optical components e.g. the beam splitter, collimator, objective lens etc are illustrated.

Each radiation source 7a, 7b, 7c is arranged to provide a separate beam of radiation, substantially parallel to the optical axis 19a of the optical scanning device. One of the radiation sources 7b is arranged to provide a beam that is aligned with the optical axis 19a. The other radiation sources 7a, 7c are arranged to provide radiation beams that are parallel to, but separated from, the optical axis 19a. This separation has been exaggerated, for ease of explanation. A typical value of the separation of the radiation beams, as emitted from the radiation sources, is less than 200 microns (and often, approximately 100 microns) from the optical axis 19a. In the Figures, only the chief ray of each radiation beam is illustrated.

In the embodiment shown in FIG. 4, the beam-deflecting element 30a is arranged to simply deflect the radiation beam from radiation source 7a towards the optical axis 19a. Only the central portion of the radiation beam is illustrated by the arrows. The beam-deflecting element 30a can be any beam deflector element comprising a birefringent material, as described herein. If the optical scanning device is arranged as in FIG. 1 with the beam deflector 30a adjacent the collimator, and with the focal length of the collimator lens approximately 10 mm, then the path of the radiation beam is tilted by 10 milliradian. If the beam-deflecting element is utilized with a thickness (i.e. length along the optical axis) of 1 mm, then the optical path is shifted by approximately 10 micron. Such a small shift has a negligible effect on the readout performance of the optical scanning device i.e. in the ability of the optical scanning device to scan the optical record carrier.

In the alternative embodiment shown in FIG. 5, the beam-deflecting element 30b is arranged not only to refract the radiation beam from source 7a towards the optical axis 19a, but also to subsequently refract the radiation beam along the optical axis 19a. The radiation beam from radiation source 7a is substantially aligned along the optical axis 19a. The beam-deflecting element is arranged to refract the radiation beam from source 7a such that the optical axis of this second radiation beam substantially coincides with the optical axis of the radiation beam from source 7b.

A single beam-deflecting element 30a could be utilized to provide such a function e.g. similar to element 330 described in relation to FIG. 3. Alternatively, two separate beam-deflecting elements could be utilized to provide the same function.

FIG. 6 shows an alternative implementation of an optical scanning device, in this instance incorporating two beam-deflecting elements 30c, 30d. Additionally, the optical scanning device comprises a polarization-changing element 301, arranged to change the polarization of at least one of said beams.

The polarization-changing element may be arranged to change the polarization of two of said beams. However, in this particular embodiment, the function of the polarization-changing element 301 is wavelength dependent, and is arranged so as to change only the polarization of one of said beams of predetermined wavelength. The polarization-changing element 301 is arranged to not change the polarization of the other beams of different wavelengths. The polarization-changing element is a half-wave plate. Thus, it can change horizontally polarized light to vertically polarized light, and visa versa, for beams of appropriate wavelength.

In the particular embodiment shown, radiation source 7a emits radiation with a first polarization p₁, with radiation sources 7b and 7c emitting radiation having a polarization p₃ orthogonal to p₁. Beam-deflecting element 30c is arranged to refract radiation having one polarization (p₁), and to allow light of the other polarization (p₃) to be transmitted without substantial refraction through the element 30c. Beam-deflecting element 30d is arranged to perform the opposite function i.e. to refract light of polarization p₃, and to transmit without refraction light of polarization p₁.

The term “without substantial refraction” indicates that the radiation beam is transmitted through the beam-deflecting element, without the beam being deflected by refraction within the element by an amount that will alter the performance of the optical device due to the position of the spot arising from the radiation beam being adjusted. Substantially non-refracting thus amounts to an angle of refraction of less than 0.1 degrees.

Thus, the deflecting element 30c acts to refract radiation from radiation source 7a towards the optical axis 19a. Radiation of the other polarization, from radiation sources 7b and 7c, is transmitted unimpeded through the beam-deflecting element 30c.

Polarization-changing element 301 is arranged, in this particular embodiment, so as to change only the polarization of radiation of the wavelength emitted from radiation source 7b. The element 301 is positioned between the two beam-deflecting elements. Thus, radiation from radiation source 7b, as incident on beam-deflecting element 30d, is of polarization p₁ (orthogonal to polarization p₃). Thus, beams from radiation sources 7a and 7b, of polarization p₁, are transmitted without substantial refraction through beam-deflecting element 30d. Beam-deflecting element 30d is arranged to refract radiation of polarization p₃ (from radiation source 7c) towards the optical axis 19a.

Thus, by appropriate application of beam-deflecting elements, and a polarization-changing element located between the beam-deflecting elements, each of the radiation beams from the separate radiation sources can be arranged to be converged on a similar spot on the information layer 2 of the optical record carrier 3.

Whilst the elements 30c, 30d and 301 have been indicated as discrete elements, it will be appreciated that a compound structure may be formed incorporating all of the elements. For instance, a polarization-changing element (such as a half-wave plate) could be incorporated within a birefringent material of a single beam-deflecting element, with the functions of beam-deflecting elements 30c and 30d being provided by different surfaces of said beam-deflecting element.

By incorporating a beam deflector element utilizing a birefringent material into an optical scanning device, a multi-radiation beam optical scanning device can easily be implemented, without mechanical fatigue, and with relatively low loss of radiation due to the beam deflector element.

1. An optical scanning device (1) for scanning an information layer (2) of an optical record carrier (3), the device comprising:
a radiation source (7; 7a, 7b, 7c) for providing at least a first radiation beam (4, 15, 20) of a first polarization along a first optical path, and a second radiation beam of a second, different polarization along a second, different optical path;
an objective lens system (8), having an optical axis (19a, 19b), for converging said radiation beams on said information layer; and
at least one beam-deflecting element (30; 330; 30a; 30b; 30c) comprising a layer of birefringent material (334, 336) orientated such that each of said polarized radiation beams experiences a different index of refraction upon passing through the birefringent material, and arranged to refract at least said first radiation beam towards the optical axis (19a, 19b).

2. An optical scanning device as claimed in claim 1, further comprising:
a detector (23) for detecting at least a portion of each of said radiation beams reflected from the optical record carrier (3); and
a beam splitter (9)) for transmitting the incident radiation beam received from the radiation source (7; 7a, 7b, 7c) towards the optical record carrier (3), and for transmitting said reflected radiation beams received from the optical record carrier (3), towards the detector (23);
wherein at least one of said beam-deflecting elements (30; 330; 30a; 30b; 30c) is positioned (31) between the radiation source (7; 7a, 7b, 7c) and the beam splitter (9).

3. A device as claimed in claim 1, further comprising:
a detector (23) for detecting at least a portion of each of said radiation beams reflected from the optical record carrier (3); and
a beam splitter (9) for transmitting the incident radiation beam received from the radiation source (7; 7a, 7b, 7c) towards the optical record carrier (3), and for transmitting said reflected radiation beams received from the optical record carrier (3), towards the detector (23);
wherein at least one of said beam-deflecting elements (30; 330; 30a; 30b; 30c) is positioned between the beam splitter (9) and the detector (23).

4. An optical scanning device as claimed in claim 1, further comprising:
a detector (23) for detecting at least a portion of each of said radiation beams reflected from the optical record carrier (3); and
a beam splitter (9) for transmitting the incident radiation beam received from the radiation source towards the optical record carrier (3), and for transmitting said reflected radiation beams received from the optical record carrier (3), towards the detector (23);
wherein at least one of said beam-deflecting elements (30; 330; 30a; 30b; 30c) is positioned between the beam splitter (9) and the position of the optical record carrier (3).

5. A device as claimed in claim 1 wherein the birefringent material (334, 336) has two surfaces extending transverse the optical paths of the radiation beams, a first surface being arranged to refract the first radiation beam towards the optical axis, and a second surface being arranged to subsequently refract the first radiation beam substantially along the optical axis.

6. A device as claimed in claim 1, wherein said beam-deflecting element further comprises a transparent material (332) contacting the birefringent material (334, 336) and extending transverse the optical paths of the optical radiation beams, having a refractive index nₜ where n₁≧nₜ≧n₂, n₁ and n₂ being respectively the maximum and minimum refractive indices of the birefringent material; wherein the preferential axis of the birefringent material is orientated such that at least one of said polarized radiation beams experiences a refractive index of substantial nₜ upon passing through the birefringent material.

7. A device as claimed in claim 1, wherein said beam-deflecting element (7; 7a, 7b, 7c) further comprises an additional layer of birefringent material (336) having a preferential axis orientated such that each polarized radiation beam experiences a different index of refraction upon passing through the additional layer of birefringent material.

8. A device as claimed in claim 1, wherein said beam-deflecting element is arranged to transmit at least one of the radiation beam provided by the radiation source, without substantial refraction of the beam.

9. A device as claimed in claim 1, wherein the radiation source (7c) is arranged to provide a third radiation beam along a third, different optical path, each radiation beam having a different wavelength; and
the optical scanning device (1) further comprises at least once half-wave plate (301) for altering the polarization of incident radiation beams, the half-wave plate being arranged to alter the polarization of at least one of said radiation beams and not to alter the polarization of at least another one of said radiation beams.

10. An optical scanning as claimed in claim 9, further comprising at least one further beam-deflecting element (30d) comprising a birefringent material orientated such that different polarized radiation beams experience a different index of refraction upon passing through the birefringent material, said half-wave plate (301) being positioned between two of the beam-deflecting elements (30c, 30d).

11. A method of manufacturing an optical scanning device (1) for scanning an information layer (2) of an optical record carrier (3), the method Comprising:
providing a radiation source (7; 7a, 7b, 7c) for providing at least a first radiation beam (4, 15, 20) of a first polarization along a first optical path, and a second radiation beam of a second, different polarization along a second, different optical path;
providing an objective lens system (8), having an optical axis (19a, 19b), for converging said radiation beams on said information layer (2); and
providing at least one beam-deflecting element (30; 330; 30a; 30b; 30c) comprising a birefringent material (334, 336) orientated such that each of said polarized radiation beams experiences a different index of refraction upon passing through the birefringent material, and arranged to refract at least said first radiation beam towards the optical axis (19a, 19b).
